(19) United States
(12) Patent Application Publication
(10) Pub. No.: US 2009/0284416 A1
(43) Pub. Date: Nov. 19, 2009

(54) System and Method for Configurable Information Handling System Wireless Network Antenna

(76) Inventors: Liam B. Quinn, Austin, TX (US); Bruce Montag, Austin, TX (US); Keith Hendrickson, Round Rock, TX (US)

Correspondence Address: HAMILTON & TERRILE, LLP, P.O. BOX 203518, AUSTIN, TX, 78720, US

(21) Appl. No.: 12/121,035

(22) Filed: May 15, 2008

(51) Int. Cl. H01Q 3/00

(52) U.S. Cl. 342/377

(57) ABSTRACT

An information handling system interacts with plural classes of wireless communications devices having plural frequency bands with integrated wireless components having a common antenna. The antenna has plural segments that selectively interface with the wireless components to form antenna configurations associated with the frequency bands. For example, a grid of antenna segments formed on an integrated circuit selectively interface the segments with wireless components by switching on and off an interface between the wireless components and the segments. In one embodiment, the segments are selected and deselected to form desired antenna configurations with MEMS devices disposed as an array in the grid of segments.

### BACKGROUND OF THE INVENTION

1. Field of the Invention

The present invention relates in general to the field of information handling system wireless networking, and more particularly to a system and method for configurable information handling system wireless network antenna.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system manufacturers have succeeded over time in packaging increased processing capabilities in smaller chassis sizes. In particular, this trend has resulted in ever more powerful portable information handling systems. The processing capability of portable information handling systems has increased to the point where many end users have replaced desktop information handling systems with portable systems. Portable information handling systems typically have an integrated power source, such as a battery, an integrated display, such as a liquid crystal display (LCD), and an integrated keyboard so that an end user can carry the system and use the system free from any physical connections, such as electrical outlets or peripheral cables. In order to provide networking capability, portable information handling systems often include integrated wireless devices that support communication through wireless local area networks (WLAN), such as 802.11 b, g and n compliant networks, through wireless wide area networks (WWAN), such as cellular telephone networks, through Bluetooth, though ultrawide bandwidth (UWB) and or through WiMax. Wireless networking technology has made portable information handling systems an attractive alternative for end users who can communicate through the Internet from virtually anywhere.

One difficulty with wireless networking on a portable information handling system is that the various wireless networking technologies use different frequency bands and channels to communicate. In order to have optimal communication through a wireless network, an information handling system typically must have an antenna design capable of supporting each of the frequencies for the underlying wireless networks. Thus, integrating multiple wireless devices into a portable information handling system typically requires an antenna structure for each wireless device class. Integrating multiple antenna systems into an information handling system chassis increases design complexity and presents difficulty with portable information handling systems having small chassis sizes. An alternative is to limit the number of wireless frequencies that a portable information handling system supports, however, this has a negative impact on end user satisfaction. The challenge is to have design flexibility and support in the system to adapt and operate across multiple frequency bands to support multiple use cases. End users have come to expect that multiple wireless classes will be supported by an information handling system's integrated wireless networking subsystem.

### SUMMARY OF THE INVENTION

Therefore a need has arisen for a system and method which supports multiple wireless device classes through a common antenna array structure with a smart antenna system.

In accordance with the present invention, a system and method are provided which substantially reduce the disadvantages and problems associated with previous methods and systems for integrating multiple wireless components into an information handling system that use multiple antennas. A common antenna supports plural wireless components by selectively configuring antenna segments of the antenna to support each wireless component. The antenna segments are selectively interfaced with the wireless component to form an antenna configuration having a conductive path that supports the interfaced wireless component.

More specifically, an information handling system has plural processing components to process information and one or more integrated wireless components to wirelessly communicate information with one or more wireless communication devices. For example, a wireless transceiver has a first component that supports wireless local area networks, such as 802.11 b, g and n compliant networks operating in a first frequency band, and a second component that supports wireless wide area networks, such as with cellular telephone communications in a different frequency band. A connection manager determines a wireless component of the information handling system for communication with an external wireless communication device, such as a wireless access point or cellular telephone tower, and configures one or more integrated antennas to support the communication. The antenna system array has plural segments arranged in a grid with each segment selectively interfaced with the wireless component by a connection device, such as a switch or a MEMS device. For example, an array of MEMS devices disposed in the grid selectively interfaces antenna segments with the wireless component to form a conductive transmission path that supports the frequency bands associated with the wireless component. The connection manager, such as a software module running on processing components of the information handling system, adjusts the conductive path to support optimal communication, such as with beam and null steering.

The present invention provides a number of important technical advantages. One example of an important technical advantage is that a common antenna array structure provides support for multiple wireless device classes that communicate through a variety of frequency bands. A universal connection manager adjusts a common antenna array structure using MEMS technology to select and tune the frequency bands and spectrum for a selected wireless device and application. Having a single antenna structure reduces the space needed for the antenna in the chassis, thus reducing chassis size and design complexity. Silicon geometries of 65 nm in CMOS is enabling MEMS multi-function wireless single chip solutions. For example, a single integrate circuit chip providing an 802.11n solution might also support GPS, BT and FM wireless communication. A reduction in silicon size allows architectures that reduce packaging and layout footprint and eliminate multiple coaxial feed cables communicating between multiple antenna array structures. A software controlled MEMS antenna array structure provides an integrated and tunable RF device L/C element that not only adjusts its mechanical structure for a desired frequency band but also supports beam and null steering and output power level control down to specific profiles for channel segments within a frequency spectrum band.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a configurable wireless network antenna;

FIG. 2 depicts an antenna grid of plural segments having an array of MEMS to selectively interface segments with a wireless component in desired antenna configurations; and

FIG. 3 depicts an integrated circuit having selectively interfaced antenna segments to form plural antenna configurations for supporting plural wireless components having plural frequency bands, with switching to form antenna configurations controlled by a universal connection manager application.

### DETAILED DESCRIPTION

Plural selectively interfaced antenna segments form plural antenna configurations to support plural wireless components of an information handling system communication through plural frequency bands. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

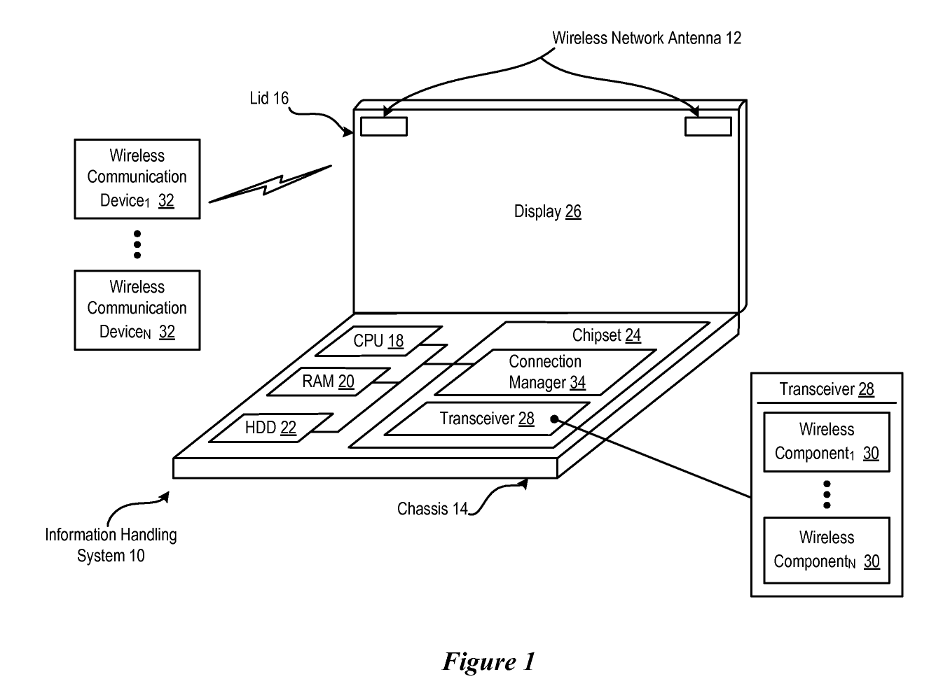

Referring now to FIG. 1, a block diagram depicts an information handling system 10 having a configurable wireless network antenna 12. Information handling system 10 has a portable configuration with a chassis 14 and a rotationally coupled lid 16. Chassis 14 supports a plurality of processing components that cooperate to process information, such as a CPU 18, RAM 20, a hard disk drive 22 and a chipset 24. Lid 16 has an integrated display 26 interfaced with the processing components to present information as visual images. In the example embodiment depicted by FIG. 1, chipset 24 includes a transceiver 28 that includes plural wireless components 30 for communicating with plural external wireless communication devices 32. For example, different wireless components 30 are supported by different firmware modules or by circuits within an integrated circuit that combines support for plural wireless components, such as an integrated circuit that supports Wi-Fi, GPS, BT and FM communications. In alternative embodiments, separate transceivers independent of chipset 24 and each other may be used to communicate with the plural wireless communication devices 32.

In order to communicate with wireless communication devices 32, a connection manager 34 determines the class of wireless communication that is desired and configures wireless antenna 12 to support the communication. For example, if communication is desired by an end user with a wireless local area network, connection manager 34 configures wireless network antenna to support frequency bands associated with wireless local area networks so that wireless components 30 associated with wireless local area networks can attempt to establish communication with a wireless communication device 32 that is associated with wireless local area network communication, such as 802.11 b, g or n compliant communication. Once communication is established, connection manager 34 adjusts the configuration of antenna 12 to adapt to the type of communication and the conditions of the communication, such as by performing beam and null steering to improve signal strength. If communication is desired with a wireless wide area network, connection manager 34 configures wireless network antenna 12 to support frequency bands associated with wireless wide area networks, such as cellular telephone frequency bands. The selection of the wireless component to establish communication is managed through an operating system interface with connection manager 34 or other type of interface, such as firmware-based interface or an application based interface.

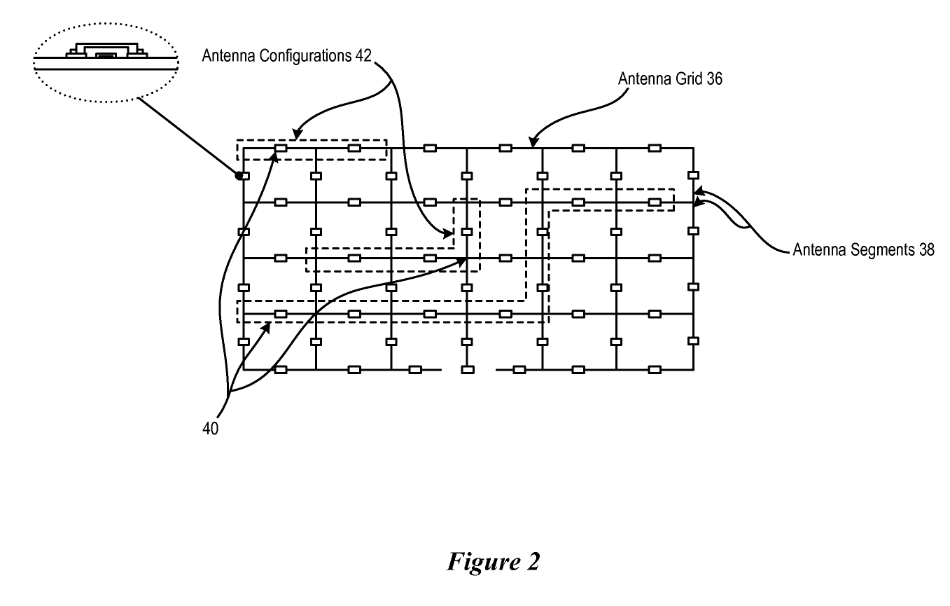

Referring now to FIG. 2, an antenna grid 36 depicts plural segments 38 having an array of MEMS 40 to selectively interface segments 38 with a wireless component in desired antenna configurations 42. Antenna grid 36 is, for example, a plurality of antenna segments 38 made of conductive material disposed on a silicon substrate. MEMS 40 are MicroElectroMechanical System devices that have optical, mechanical and/or electronic parts incorporated in a silicon substrate that can sense, control and actuate on a micro scale individually or arrayed on a macro scale. MEMS 40 are RF devices that interface an associated antenna segment 38 with a wireless component 30 to receive and transmit wireless signals for the wireless component. MEMS 40 thus provide a tunable antenna array element configurable to the radiating source, such as the frequency band used by the wireless component. Various antenna configurations 42 are selected by connection manager 34 by switching on the MEM 40 associated with the segments 38 that fall along a desired conductive path. For example, different frequency bands associated with different wireless components 30 and communication devices 32 will activate MEMS selected by connection manager 34 so that the conductive path of one or more antenna configurations 42 provides an antenna adapted for the selected frequency band. Once wireless communication is established, connection manager 34 can alter the antenna configuration 42 to improve signal strength, such as by performing beam and null steering. If a different wireless component is selected, connection manager 34 reconfigures MEMS 40 to define a conductive path for an antenna configuration 42 that optimizes communication for the frequency band of the new wireless component 30. Although FIG. 2 depicts MEMS 40 as the connection device to form segments 38 into desired conductive paths, in alternative embodiments, other types of connection devices can interconnect segments 38 or otherwise interface segments 38 with a wireless component 30, such as switches, MOSFETs, transistors or other circuits.

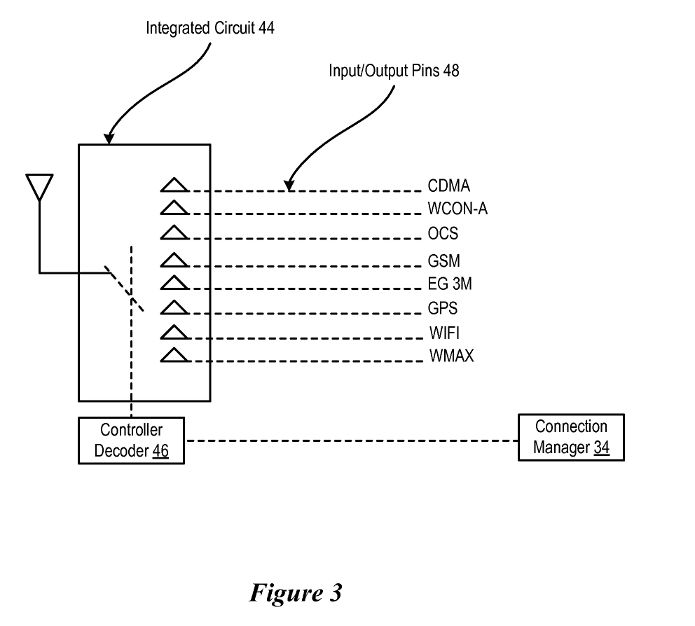

Referring now to FIG. 3, an integrated circuit 44 has selectively interfaced antenna segments to form plural antenna configurations for supporting plural wireless components having plural frequency bands. Connection manager 34 send commands to establish a desired antenna configuration to a controller decoder 46 interfaced with antenna integrated circuit 44. Controller decoder 46 selectively activates or deactivates the interface of integrated antenna segments with an associated wireless component input/output pin 48 so that a wireless component interfaced with an input/output pin can communicates through an antenna configuration within integrated circuit 44 having a desired conductive path. For example, in the embodiment depicted by FIG. 3, wireless components supported by integrated circuit 44 include CDMA, WWAN, DCS, GSM, GPS, WIFI and WMAX devices. Although the embodiment depicted by FIG. 2 has a rectangular grid of segments with an array of MEMS devices having a MEMS device associated with each segment alternative embodiments may include a variety of antenna segment configurations and connection devices.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
plural antenna segments;
a wireless component interfaced with the processing components and operable to communicate information through an antenna, the wireless component communicating information with plural wireless frequency bands, each frequency band having an associated antenna configuration; and
a connection manager interfaced with the antenna segments, the processing components and the wireless component, the connection manager operable to determine a frequency band for communicating information and to selectively connect one or more of the antenna segments with the wireless component to have the antenna configuration associated with the determined frequency band.

2. The information handling system of claim 1 wherein the plural antenna segments comprise a grid.

3. The information handling system of claim 2 further comprising connection devices disposed in the grid to selectively interface antenna segments with the wireless component in the antenna configuration associated with the determined frequency band.

4. The information handling system of claim 3 wherein the connection devices comprise MicroElectroMechanical System devices.

5. The information handling system of claim 4 wherein the grid and the MicroElectroMechanical System devices comprise structures formed on a silicon substrate.

6. The information handling system of claim 1 wherein the plural wireless frequency bands comprise at least a WIFI frequency band and a CDMA frequency band.

7. The information handling system of claim 1 wherein the plural wireless frequency bands comprise at least a WFFI frequency band and a GSM frequency band.

8. The information handling system of claim 1 wherein the connection manager is further operable to adjust the antenna configuration to provide beam and null steering.

9. The information handling system of claim 1 wherein the plural wireless frequency bands comprise a wireless local area network frequency band and a wireless wide area network frequency band.

10. A method for interfacing an information handling system with plural wireless communication devices, each wireless communication device having an associated frequency band, the method comprising:
selecting a wireless component within the information handling system for communication with a selected of the plural wireless communication devices;
interfacing plural antenna segments disposed in the information handling system to the wireless component, the plural antenna segments having a predetermined configuration for the associated frequency band; and
receiving wireless signals from the selected wireless communication device at the selected wireless component through the plural antenna segments.

11. The method of claim 10 further comprising sending wireless signals from the selected wireless component to the selected wireless communication device through the plural antenna segments.

12. The method of claim 10 further comprising:
selecting a second wireless component within the information handling system for communication with a second of the plural wireless communication devices;
interfacing plural antenna segments disposed in the information handling system to the second wireless component, the plural antenna segments having a second predetermined configuration for the associated frequency band; and
receiving wireless signals from the second wireless communication device at the second wireless component through the plural antenna segments.

13. The method of claim 10 wherein interfacing plural antenna segments further comprises selectively switching on and off conductive paths associated with the antenna segments to define an antenna shape.

14. The method of claim 13 wherein selectively switching on and off conductive paths further comprises selectively switching on and off MEMS distributed among the antenna segments.

15. The method of claim 10 wherein interfacing plural antenna segments further comprises adjusting the predetermined configuration for beam steering.

16. The method of claim 10 wherein interfacing plural antenna segments further comprises adjusting the predetermined configuration for null steering.

17. The method of claim 10 wherein selecting a wireless component comprises selecting between at least a wireless local area network component and a wireless wide area network component.

18. An integrated circuit comprising:
plural antenna segments operable to selectively form plural antenna configurations; and
plural selection devices interfaced with the antenna segments and operable to interface selected of the antenna segments with a wireless device in an antenna configuration associated with the wireless device.

19. The integrated circuit of claim 18 wherein the selection devices comprise MEMS.

20. The integrated circuit of claim 18 wherein the plural antenna segments comprise a grid.
